(19) United States
(12) Patent Application Publication
(10) Pub. No.: US 2025/0298381 A1
(43) Pub. Date: Sep. 25, 2025

(54) SAFETY AND CONTROL INTERFACE FOR SAFE VEHICLE OPERATION

(71) Applicant: Applied Electric Vehicles Ltd, Scoresby (AU)

(72) Inventors: Laksh Jaisinghani, Carrum Downs (AU); Marc Alexander, Croydon Hills (AU)

(73) Assignee: Applied Electric Vehicles Ltd, Scoresby, VI (AU)

(21) Appl. No.: 18/612,797

(22) Filed: Mar. 21, 2024

(51) Int. Cl. G05B 9/02

(52) U.S. Cl. CPC G05B 9/02

(57) ABSTRACT

A safety and control interface for safe vehicle operation is described. In one or more implementations, the safety and control interface receives a request for a service from an application executed by a first processor. The safety and control interface determines whether the application has an application permission to access the service. The safety and control interface determines whether executing the service would maintain a safety goal established for the vehicle. A second processor executes the service requested by the application based on the safety and control interface determining that the application has the application permission to access the service and that executing the service responsive to the request would maintain the safety goal established for the vehicle.

### BACKGROUND

Software-defined vehicles represent a significant evolution in vehicle design and functionality, where the vehicle's features, capabilities, and performance are primarily driven by software rather than hardware. This paradigm shift means that many aspects of the vehicle, such as infotainment systems, advanced driver-assistance systems, powertrain control system, and autonomous driving systems, can be updated, enhanced, and customized through software updates over the vehicle's service life. Software-defined vehicles leverage extensive connectivity, advanced computing platforms, and data analytics, enabling continuous improvement and personalization of the driving and passenger experience.

Software-defined vehicles present new challenges for functional safety and cybersecurity. International Organization for Standardization (ISO) defines multiple standards that address the safety and security of automotive systems in the era of software-defined vehicles. For instance, ISO 26262 focuses on the functional safety of electrical and electronic systems within road vehicles, aiming to mitigate risks associated with system failures that could lead to physical harm to drivers, passengers, pedestrians, or others. This standard encompasses the entire lifecycle of electrical and electronic systems, from design and development to decommissioning, and introduces Automotive Safety Integrity Levels (ASILs) to assess and manage risk. ISO 21434 targets the cybersecurity of road vehicles, establishing guidelines for managing cybersecurity risks to protect against unauthorized access, malicious attacks, and ensures the integrity and functionality of automotive systems. Together, these standards provide a comprehensive framework for the development, production, and maintenance of safe and secure automotive software and systems, highlighting the industry's shift towards integrating safety and cybersecurity measures in the design of modern vehicles.

Ensuring compliance with functional safety and cybersecurity standards, such as those mentioned above, presents several challenges for vehicle manufacturers due to the intricate nature of contemporary vehicle systems. The integration of advanced electronic and software components for critical functionalities, such as autonomous driving and safety mechanisms, significantly increases system complexity. This intricacy complicates the processes of identifying potential safety hazards and cybersecurity vulnerabilities, assessing risks accurately, and implementing effective mitigation strategies. Moreover, the rapid pace of technological advancements and the introduction of connected and autonomous vehicle technologies demand continuous updates to safety and security measures, challenging manufacturers to keep up with evolving standards.

### BRIEF DESCRIPTION OF THE DRAWINGS

FIG. 1 is a block diagram of a non-limiting example operating environment including a vehicle having an architecture to operate the vehicle safely via implementation of a safety and control interface.

FIG. 2 is a block diagram of a non-limiting example including a vehicle having an architecture to operate the vehicle safely via implementation of a safety and control interface.

FIG. 3 is a block diagram of a non-limiting example of a system that implements a safety control interface for safe vehicle operation.

FIG. 4 depicts an example implementation of a safety control interface for safe vehicle operation.

FIG. 5 is a sequence diagram of a non-limiting example of a safety check process implemented by a safety control interface for safe vehicle operation.

FIG. 6 depicts an example implementation of a safety control interface to allocate memory resources based on a type of operation associated with a requested service.

FIG. 7 depicts a procedure in an example implementation of a safety control interface for safe vehicle operation.

### DETAILED DESCRIPTION

### Overview

Functional safety is a critical aspect of system design that aims to minimize the risks posed by technological systems to an acceptable level, especially in environments where human safety is directly impacted. An illustrative example of functional safety in action is the design and implementation of railway crossings. A railway crossing poses an inherent risk of collision between road vehicles and trains at intersections where railways and roads cross. This risk is mitigated through a combination of barriers, alarms, and sensors. These systems work together to detect the approach and departure of trains, triggering alarms to alert nearby individuals and activating barriers to prevent vehicle access to the railway. Once the train has safely passed, the system deactivates the alarms and lifts the barriers, allowing road traffic to proceed. This setup does not eliminate the intersection between railways and roads but significantly reduces the collision risk through proactive safety measures. The essence of functional safety, as demonstrated by railway crossing example, lies in its ability to manage and mitigate hazards through engineered controls, ensuring a safer interface between humans and technological systems.

As mentioned above, ISO26262 provides standards dedicated to the functional safety of electrical and electronic systems within road vehicles. ISO26262 addresses the entire lifecycle of safety-related systems, including their design, development, production, commissioning, operation, service, and decommissioning. This standard aims to ensure that electrical and electronic systems are designed with the necessary safety measures to prevent or mitigate risks due to system failures. This standard focuses on minimizing the risk of physical injuries resulting from the malfunctioning of electrical and electronic safety-related systems.

ISO 26262 defines a principle of “freedom from interference” that ensures the functional safety of a vehicle by preventing safety-critical systems from being adversely affected by other systems or functions within the vehicle. This principle is essential for maintaining the integrity and reliability of electronic and electrical systems that perform safety functions, such as braking, steering, and powertrain control, in modern vehicles.

Freedom from interference directly supports functional safety by ensuring that safety-critical systems have dedicated resources (e.g., processing power and memory) that are not compromised by non-critical systems, faults in non-safety systems do not propagate to safety systems, potentially causing them to fail, and systems are designed with clear partitions and access controls, minimizing the risk of unintended interactions that could lead to safety hazards.

While ISO 26262 focuses on functional safety, the concept of freedom from interference also intersects with vehicle cybersecurity, particularly in the context of protecting safety-critical systems from malicious attacks. Cybersecurity measures are crucial for preventing unauthorized access and manipulation of vehicle systems that could compromise safety. In this regard, freedom from interference relates to cybersecurity by ensuring that safety-critical systems are isolated or protected from potential cybersecurity threats that could affect their operation, and by implementing access controls and monitoring mechanisms to detect and respond to cyber-attacks, thereby preserving the integrity of safety functions.

To achieve freedom from interference, various technical mechanisms can be employed. For instance, memory protection units (MPUs) and/or memory management units (MMUs) can be employed for managing access to memory resources and ensuring that software components cannot access memory regions outside of their allocated areas. Hardware and software partitioning can be used to physically or logically separate safety-critical and non-safety-critical functions. Resource management techniques can prioritize access to processor units, peripheral and input/output controllers, memory and other shared resources for safety-critical functions. Fault detection and containment mechanisms can be used to quickly identify and isolate faults, minimizing their impact on the overall system.

The concepts and technologies disclosed herein provide a safety and control interface for safe vehicle operation achieved, in part, by ensuring freedom from interference among vehicle systems, particularly vehicles that employ autonomous driving systems and electrical propulsion systems. The safety and control interface provides a secure connection between a vehicle system provided by a vehicle manufacturer and external systems, services, and applications, such as client applications, networks, and autonomous driving systems provided by other entities, e.g., an original equipment manufacturer (OEM).

In one or more implementations, the safety and control interface provides or otherwise facilitates the exposure of an autonomous driving API that enables autonomous driving services and systems to interoperate with the vehicle. This interface allows for the exchange of critical data where the autonomous driving system can submit mission and path requests, and in turn, receive information on safe trajectories, vehicle dynamics, and motion control from the vehicle system. In this manner, autonomous driving solutions, such as those offered by third parties, can operate effectively within the vehicle's ecosystem, enhancing the capabilities of autonomous vehicles by leveraging external innovation while maintaining a high standard of safety and efficiency.

In one or more implementations, the safety and control interface provides or otherwise facilities the exposure of a cloud API that enables a two-way remote connection to the vehicle through one or more mobile telecommunications networks, allowing for remote vehicle control and management as well as fleet management capabilities. The cloud API enables a broad connectivity ecosystem of vehicles, facilitating various services such as software updates, diagnostics, and remote operations. The cloud API extends the functionality of vehicles by offering opportunities for enhanced monitoring, maintenance, and control of vehicles from remote locations, thereby increasing operational efficiency and convenience.

In one or more implementations, the safety and control interface provides or otherwise exposes a client application space API that facilitates direct interaction between client applications and the vehicle system, enabling the development and integration of applications that enhance the vehicle experience. The client application space API serves as a gateway to leveraging the vehicle's capabilities and data to create innovative applications, ranging from entertainment and infotainment to advanced driver assistance systems, all while ensuring that operational integrity and safety are maintained. By providing a structured and secure access point to the vehicle's core systems, the client application space API fosters a rich ecosystem of applications that can adapt and evolve in the autonomous driving era, offering users personalized and enhanced driving experiences without compromising on safety or performance.

In one or more implementations, the safety and control interface also handles service requests from applications, determines whether the applications have the proper permissions and, if so, allows access to the requested service(s). Moreover, the safety and control interface introduces safety redundancy by determining whether executing the requested service(s) would violate any safety goals. If so, the safety and control interface can return an error to the requesting application(s) and discard the associated service request(s). The safety goals can be defined, for instance, during a vehicle commissioning process when the vehicle is programmed for its intended use case(s), e.g., as an unmanned delivery vehicle, a fully autonomous passenger vehicle, or an at least partially driver-operated vehicle. Thus, by employing the safety and control interface, the vehicle maintains freedom from interference among its systems and interactions with external systems and services.

In some aspects, the techniques described herein relate to a system including one or more subsystems of a vehicle, each of the one or more subsystems configured to perform an operation of the vehicle, a central control unit of the vehicle, the central control unit including a first processor configured to execute applications associated with the vehicle, a safety and control interface configured to receive a request for a service from an application executed by the first processor, determine whether the application has an application permission to access the service, and determine whether executing the service would maintain a safety goal established for the vehicle, and a second processor configured to execute the service requested by the application based on the safety and control interface determining that the application has the application permission to access the service and that executing the service responsive to the request would maintain the safety goal established for the vehicle.

In some aspects, the techniques described herein relate to a system, wherein the second processor, in being configured to execute the service, is configured to cause actuation of at least one of the one or more subsystems of the vehicle.

In some aspects, the techniques described herein relate to a system, wherein the request includes the application permission.

In some aspects, the techniques described herein relate to a system, wherein the application permission is provided to the application for inclusion in the request by an authentication service.

In some aspects, the techniques described herein relate to a system, wherein the safety and control interface is further configured to receive the safety goal as part of a commissioning process.

In some aspects, the techniques described herein relate to a system, wherein the safety goal is defined by a manufacturer of the vehicle during the commissioning process.

In some aspects, the techniques described herein relate to a system, wherein the application permission is implemented to satisfy, at least in part, a safety rule applied to the vehicle.

In some aspects, the techniques described herein relate to a system, wherein the safety rule is implemented to satisfy Automotive Safety Integrity Level D (ASIL-D) operation of the vehicle.

In some aspects, the techniques described herein relate to a system, wherein the safety and control interface is configured to intercept the request sent from a connection between the first processor and the second processor.

In some aspects, the techniques described herein relate to a system, wherein the safety and control interface is configured as part of a connection between the first processor and the second processor.

In some aspects, the techniques described herein relate to a system, wherein the safety and control interface includes one or more application programming interfaces and exposes the one or more application programming interfaces to the application.

In some aspects, the techniques described herein relate to an electronic control unit for controlling operation of a vehicle, the electronic control unit including a first processor configured to execute applications associated with the vehicle, a safety and control interface configured to receive a request for a service from an application executed by the first processor, and perform a safety check to determine whether the application is allowed to utilize the service, and a second processor configured to execute the service or deny the service based on the safety check.

In some aspects, the techniques described herein relate to an electronic control unit, wherein, in being configured to perform the safety check, the safety and control interface is configured to determine whether the application has an application permission required to access the service.

In some aspects, the techniques described herein relate to an electronic control unit, wherein, in being configured to perform the safety check, the safety and control interface is configured to, responsive to determining that the application does not have the application permission required to access the service, discard the request and instruct the second processor to deny the service.

In some aspects, the techniques described herein relate to an electronic control unit, wherein, in being configured to perform the safety check, the safety and control interface is configured to, responsive to determining that the application does have the application permission required to access the service, determine whether the service is associated with one or more safety goals.

In some aspects, the techniques described herein relate to an electronic control unit, wherein, in being configured to perform the safety check, the safety and control interface is configured to, responsive to determining that the service is not associated with the one or more safety goals, instruct the second processor to execute the service.

In some aspects, the techniques described herein relate to an electronic control unit, wherein, in being configured to perform the safety check, the safety and control interface is configured to, responsive to determining that the service is associated with the one or more safety goals, instruct the second processor to determine whether the one or more safety goals would be maintained if the service is executed.

In some aspects, the techniques described herein relate to an electronic control unit, wherein, in being configured to perform the safety check, the safety and control interface is configured to, responsive to determining that the one or more safety goals would be maintained if the service is executed, instruct the second processor to execute the service.

In some aspects, the techniques described herein relate to an electronic control unit, wherein, in being configured to perform the safety check, the safety and control interface is configured to, responsive to determining that the one or more safety goals would not be maintained if the service is executed, discard the request and instruct the second processor not to execute the service.

In some aspects, the techniques described herein relate to a method including receiving, by a safety and control interface of an electronic control unit of a vehicle, a request for a service from an application, determining, by the safety and control interface, whether the application has a permission to access the service, responsive to determining that the application has the permission to access the service, determining, by the safety and control interface, whether the service is associated with a safety goal, responsive to determining that the service is associated with the safety goal, determining, by the safety and control interface, whether the safety goal would be maintained if the service is executed, and responsive to determining that the safety goal would be maintained if the service is executed, instructing, by the safety and control interface, a processor of the electronic control unit, to execute the service, at least in part, by actuating one or more subsystems of the vehicle.

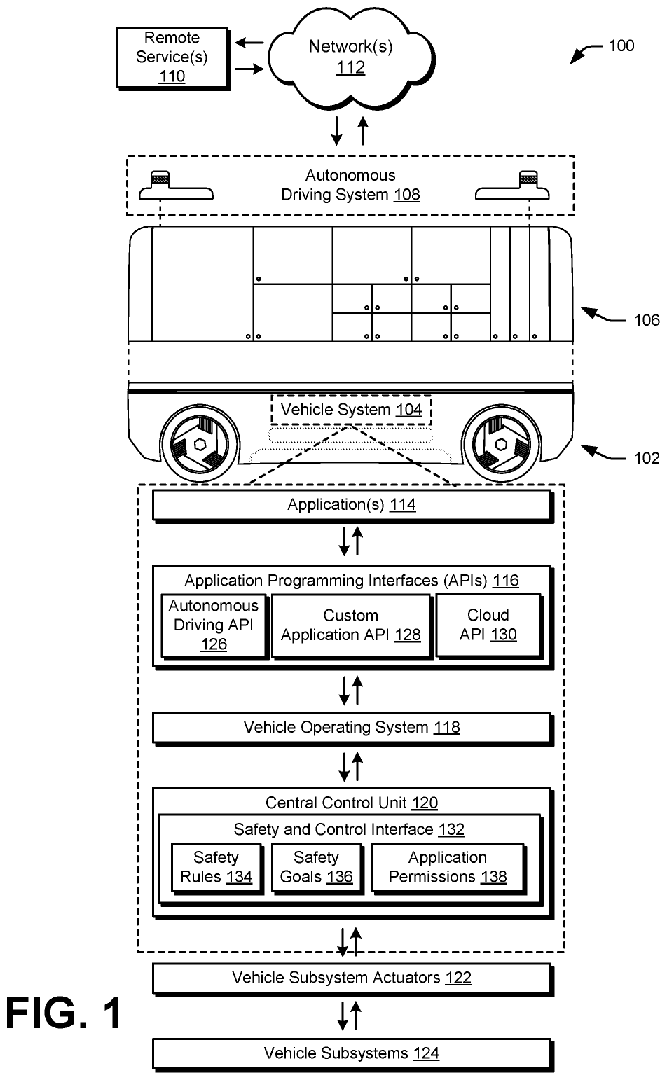

FIG. 1 is a block diagram of a non-limiting example operating environment 100 including a vehicle 102 having a vehicle system 104 configured to operate the vehicle 102 safely. The operating environment 100 can be or can include any of a variety of vehicle operating environments, examples of which include but are not limited to a roadway, a traffic scenario, an off-road area (e.g., a construction site, a mining operation, a recreational area), in the air, on or in the water, on or in other substances (e.g., within fluids and/or cellular material), in space, and other public or private spaces, to name a few. The vehicle 102 may be any type of vehicle including, for example, ground vehicles (e.g., truck, car, van, tractor-trailer, tank, etc.), air vehicles, rail vehicles, marine vehicles, space vehicles, or other types of vehicles. The vehicle 102 in at least one example is unmanned (e.g., autonomously controlled, remotely controlled), and in at least one other example the vehicle 102 is manned (e.g., semi-autonomously controlled, at least partially human operated).

The vehicle 102, in one or more implementations, is modular and enables additional functionality to be added as-needed depending on the intended application of the vehicle 102. Additional functionality can be added to the vehicle 102 through one or more pods 106. In the illustrated example, a pod 106 is disposed on top of the vehicle 102, e.g., relative to a surface on which the vehicle 102 travels. In one or more implementations, the pod 106 may be integral with the vehicle 102 in any of a variety of other ways, such as disposed on a side of the vehicle, beneath a body of the vehicle, and so on. The pod 106 can include hardware, software, and/or structural components depending on the needs of the intended application. For example, the pod 106 can be designed to provide a mobile vending service can include a structure to store goods (e.g., food, products, and so on), refrigeration components if needed, payment systems and associated software, and vending hardware (e.g., robotic arms). As another example, the pod 106 can be designed to transport human passenger can include a passenger compartment including seats, seat belts, other safety equipment (e.g., airbags), infotainment systems, lighting systems, sound systems, HVAC systems, and so on.

As noted above, the vehicle 102 can be operated in an at least partially autonomous mode. To enable autonomous functionality, the vehicle 102 can implement an autonomous driving system 108. The autonomous driving system 108 can be provided by the manufacturer of the vehicle 102, by a third-party, or by an original equipment manufacturer (OEM). In this manner, the vehicle 102 can be catered to the design and implementation requirements of its intended application. The autonomous driving system 108 provides the vehicle 102 with road visibility, perception, and compute capabilities. Additionally, the autonomous driving system 108 can interact with off-vehicle autonomous driving systems (not shown) that can aid the vehicle 102 when navigating particularly difficult areas, such as cities in which on-vehicle components may operate less effectively due to interference and/or other external factors.

The vehicle 102 can be managed, at least in part, via one or more remote services 110 accessible via one or more networks 112. The one or more remote services 110 can provide, for instance, fleet management, over-the-air (OTA) updates, and remote control of the vehicle 102. The one or more networks 112 can be implemented, at least in part, via one or more mobile telecommunications technologies such as 3^{rd} Generation Partnership Project (3GPP) 4G, 5G, and greater generation standards. The one or more networks 112 can be implemented alternatively or additionally using other wireless technologies such as WI-FI, near-field communications, and Bluetooth®. The one or more networks 112 can span any geographical area. For instance, the one or more networks 112 can be or can include one or more local area networks (LANs), one more metropolitan area networks (MANs), one or more wide area networks (WANs), one or more storage area networks (SANs), one or more controller area networks (CANs), one or more personal area networks (PANs), one or more global area networks (GANs), or any combination thereof. Public and private variations of the aforementioned networks are contemplated.

The vehicle system 104 provides software, electrical, and electronics components designed to control operation of the vehicle 102, ensuring compliance with safety standards (e.g., one or more ASIL safety standards) and maintaining freedom from interference. In the illustrated example, the vehicle system 104 includes one or more applications 114, one or more application programming interfaces (APIs) 116, and a vehicle operating system 118. The vehicle operating system 118 manages hardware resources, at least in part, provided by a central control unit 120 that, in turn, controls the operation of one or more vehicle subsystem actuators 122 to actuate one or more vehicle subsystems 124.

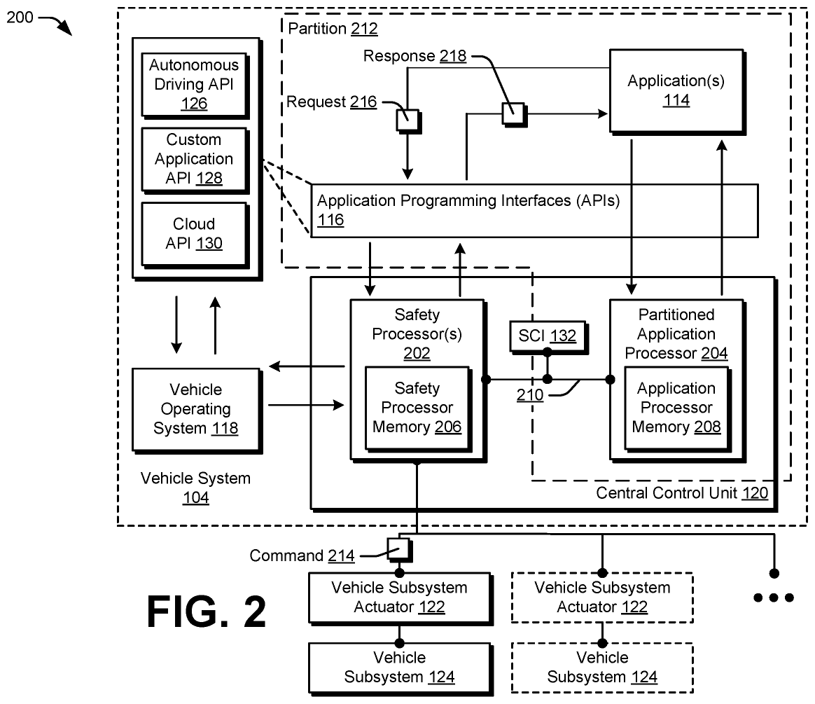

The application(s) 114 can be or can include custom applications, third-party applications, OEM applications, or applications provided by the manufacturer of the vehicle 102. Examples of the application(s) 114 include but are not limited to applications to control vehicle user interfaces, in-vehicle infotainment, power doors, HVAC, lighting, extensible tools, and so forth. It should be understood, however, that the application(s) 114 can be any application that is executed, at least in part, by the central control unit 120 to perform one or more operations on, in, about, or on behalf of the vehicle 102. The application(s) 114 can be executed by the central control unit 120 with or without external influence, such as input or other instructions provided by a user (not shown), the autonomous driving system 108, and/or the remote service(s) 110. Additional details regarding the application(s) 114 will be provided below with reference to FIG. 2.

The APIs 116 include an autonomous driving API 126, a custom application API 128, and a cloud API 130. The autonomous driving API 126 enables third-party autonomous driving systems, such as the autonomous driving system 108, to interoperate with the vehicle system 104. In this implementation, the autonomous driving system 108 provides mission and path requests, and the vehicle system 104 provides safe trajectory, vehicle dynamics, and motion control. The custom application API 128 provides developers with direct access to the vehicle system 104 for the development of the application(s) 114 that enhance the vehicle experience. The cloud API 130 allows two-way remote connections to the vehicle 102 via a network connection facilitated, for example, by the network(s) 112 enabling remote vehicle control, vehicle management, and fleet control as part of the remote service(s) 110.

The vehicle operating system 118 manages hardware resources, such as the central control unit 120, and provides services, creating an environment in which the applications 114 can be executed. Although a single vehicle operating system 118 is shown, in some implementations, multiple vehicle operating systems 118 are used. In one particular implementation, the vehicle operating system 118 is a containerized operating system and can be instantiated in multiple containers in a virtualization scheme to execute the application(s) 114 in isolated spaces.

The central control unit 120 includes one or more processors configured to execute the application(s) 114 to perform operations, such as by interacting with the vehicle subsystem actuator(s) 122 to actuate the vehicle subsystem(s) 124. Examples of the vehicle subsystems 124 include but are not limited to steering control, brake control, motor control, wing control, rotor control, motion control, traction energy, energy management, power, battery and charging, connectivity (e.g., data and telemetry, cellular, Bluetooth, near-field communication (NFC), 5G, etc.), sensors (e.g., camera(s), proximity, lidar, radar, temperature, etc.), human machine user interfaces of the vehicle 102 (e.g., screens and/or display devices), in-vehicle infotainment, HVAC (heating, ventilation, and air conditioning), lighting (e.g., interior and/or exterior), windshield and/or other wipers, seating, locking (e.g., doors), window actuation, alarms and alerts, payload services, and extensible-assembly control (e.g., pod control, exterior tool control, etc.), to name just a few. Additional details regarding the central control unit 120 will be described below with reference to FIG. 2.

In the illustrated example, the central control unit 120 includes a safety and control interface 132. The safety and control interface 132 provides a set of instructions used by the applications(s) 114 that the central control unit 120 will respond to given certain safety rules 134, safety goals 136, and application permissions 138. In one or more implementations, the safety and control interface 132 is configured to implement, at least in part, one or more of the APIs 116.

In certain implementations, the safety and control interface 132 is designed to ensure an application 114 operates without external interference. The safety and control interface 132 achieves this by only revealing the services and/or instructions that the application 114 is authorized to use. Additionally, the safety and control interface 132 manages access by approving, executing, or denying requests. This selective exposure of services simplifies the process of achieving certification and ensures safe, protected operation. Specifically, it allows an ASIL certifier to verify that only approved services or instructions are accessible. Furthermore, the application benefits from an added layer of safety by being able to filter its requests based on allowed instruction/service IDs. This feature not only enhances safety but may also enable the application to improve its ASIL certification level, potentially moving from quality management to higher levels like ASIL-A or B.

The safety rules 134 provide directives or principles that dictate what actions are allowed or prohibited in association with the use and/or operation of the vehicle 102. In one or more implementations, the safety rules 134 correspond to at least one safety standard for operating vehicles, such as the vehicle 102, examples of which include ASIL D, ASIL C, ASIL B, and ASIL A. ISO 26262 defines a set of functional safety requirements of different electrical and electronics systems in a vehicle. In some jurisdictions, adherence to this standard is a condition for allowing a vehicle to operate on a road. The standard assigns an ASIL to each part or function of a vehicle. As noted above, there are four different ASILs including ASIL-A, which is assigned to vehicle functions and parts that present a lowest risk to safety and ASIL-D, which is assigned to vehicle functions and parts that present a highest safety risk. For example, ASIL-D is used for vehicle components involved in high exposure driving situations where malfunctions cause vehicles to be most difficult to control, which can lead to death or major bodily harm.

Other examples of safety standards, which may additionally or alternatively correspond to or otherwise be maintained by adhering to the safety rules 134, include but are not limited to, Safety Integrity Level 4+ (SIL-4+), SIL-4, SIL-3, SIL-2, SIL-1, Category A, Category B, Category C, Category D, Category E, Design Assurance Level A (DAL-A), DAL-B, DAL-C, DAL-D, and DAL-E, to name just a few. In this way, if operation of the vehicle 102 satisfies the safety rules 134, then the vehicle's 102 operation satisfies (i.e., complies with) the standard to which the safety rules 134 correspond. Consider an example in which the safety rules 134 correspond to ASIL-D. In this example, if operation of the vehicle 102 satisfies the safety rules 134, then the vehicle's 102 operation therefore satisfies ASIL-D.

The safety goals 136 represent desired outcomes that a person, organization, the vehicle 102 itself, and/or any other entity aims to achieve. The safety goals 136 can be used as part of a safety check. The safety check ensures that the application(s) 114 do not access to services of the vehicle 102 if the access would violate the safety goals 136, even if the application(s) 114 have appropriate application permissions 138. In some instances, the safety goals 136 can be achieved by strict adherence to the safety rules 134. In other instances, the safety goals 136 are aspirational or otherwise exceed the requirements specified in the safety rules 134. In one or more implementations, the safety goals 136 are provisioned by the manufacturer of the vehicle 102 as part of a commissioning process during which software components, such as the application(s) 114 and the vehicle operating system 118, are installed, configured, tested, validated, and fine-tuned prior to deploying the vehicle 102 for its intended purpose.

The application permissions 138 define to which services of the vehicle 102 the application(s) 114 have access and what operations can be performed. The application permissions 138 are used by the safety and control interface 132 to grant or deny the application(s) 114 authority to use specific resources and/or execute certain operations. In this manner, the application permissions 138 can be used to ensure that the safety rules 134 are satisfied with respect to the services the application(s) 114 can and cannot access.

FIG. 2 is a block diagram of a non-limiting example 200 of a vehicle system that implements a safety and control interface for safe vehicle operation. For ease of description, the example 200 is described in the context of operating environment 100 shown in FIG. 1 including with reference to similar labeled elements. For example, the example 200 depicts the vehicle system 104 introduced in FIG. 1 connected to the vehicle subsystem actuators 122 to control various functions of the vehicle 102.

In this example 200, the central control unit 120 includes safety processor(s) 202 and a partitioned application processor 204. In one or more implementations, the partitioned application processor 204 is partitioned from other hardware of the central control unit 120, e.g., from the safety processor(s) 202, in any of a variety of ways. In at least one variation, for instance, the partitioned application processor 204 is separate hardware from the safety processor(s) 202, e.g., a separate processing unit and/or processor card. Alternatively, or additionally, the partitioned application processor 204 is “firewalled” from other components of the central control unit 120, e.g., from the safety processor(s) 202. By way of example, at least one of a physical device or software implements a firewall between the partitioned application processor 204 and other components of the central control unit 120.

Further, in at least one implementation, the safety processor(s) 202 and the partitioned application processor 204 each include respective memory. For example, the safety processor(s) 202 includes safety processor memory 206 and the partitioned application processor 204 includes application processor memory 208. As part of partitioning the partitioned application processor 204 from other hardware of the central control unit 120, in one or more implementations, the application processor memory 208 is isolated, such as from the safety processor memory of 206. In such implementations, the partitioned application processor 204 may be limited to accessing the application processor memory 208 and/or may be prevented from directly accessing the safety processor memory 206. It is to be appreciated that the partitioned application processor 204 may be partitioned from the safety processor(s) 202 and other components of the central control unit 120 and/or the vehicle 102 in a variety of ways.

In one or more implementations, the central control unit 120 is an electronic control unit or “ECU,” or the central control unit 120 is included in an electronic control unit. Thus, in at least one implementation, the safety processor(s) 202 and the partitioned application processor 204 are all included as part of, or in, a single electronic control unit. This contrasts with conventional architectures that include a distributed network of multiple electronic control units disposed throughout the vehicle, such as an architecture having individual electronic control units for each vehicle subsystem or having ECUs for many such vehicle subsystems.

Further, in at least one implementation, the central control unit 120 includes two of the safety processor(s) 202. In such implementations, the safety processor(s) 202 may be configured to redundantly operate the vehicle 102. For instance, each of those safety processor(s) 202 may be configured to receive the same inputs from perception devices and/or systems of the vehicle 102, perform vectoring computations in the same manner, output the same motion control commands based on same vectoring computations, and so forth. In this way, in the event a first of the safety processor(s) 202 fails or experiences an issue or malfunction that could impact safety, the second of the safety processor(s) 202 can seamlessly assume control of the vehicle 102.

The safety processor(s) 202 controls the motion and vectoring of the vehicle 102. In other words, the safety processor(s) 202 maintains an operating state of the vehicle 102 (e.g., the vehicle's position and location) within a safe operating envelope of the vehicle 102. By contrast, the partitioned application processor 204 is configured to execute the application(s) 114, e.g., custom, OEM, and/or third-party applications, which can call functionality provided via the APIs 116. Examples of the applications 114 include, but are not limited to, applications to control vehicle user interfaces, in-vehicle infotainment, power doors, HVAC, lighting, extensible tools, autonomous driving applications, network connectivity applications, applications that utilize the remote service(s) 110, and so forth. By partitioning the partitioned application processor 204 from the safety processor(s) 202, issues that arise due to executing the application(s) 114, such as software issues, hardware issues (e.g., of the partitioned application processor 204), and/or single event upset failures, are prevented from affecting safe motion and control of the vehicle 102. In other words, the partitioning of the partitioned application processor 204 from the safety processor(s) 202 prevents the application(s) 114 from interfering with safety-critical vehicle operations, like motion control and vectoring.

Even though the partitioned application processor 204 is partitioned from the safety processor(s) 202 in one or more ways, the partitioned application processor 204 is communicably coupled with the safety processor(s) 202 via one or more connections 210. Example wired connections include, but are not limited to, Ethernet connections or links, memory channels, buses (e.g., a data bus, a system or address bus), interconnects, through silicon vias, traces, pins and sockets, and planes, to name just a few. Other example connections include optical connections, fiber optic connections, and/or connections or links based on quantum entanglement.

The safety and control interface 132 (shown as “SCI”) can be implemented as part of the connection(s) 210 or can be implemented separately from the connection(s) 210 and can monitor communications over the connection(s) 210 to intercept, for example requests from the application(s) 114 to access the vehicle subsystem actuators 122.

In accordance with the described techniques, the safety processor(s) 202 and the partitioned application processor 204 communicate over the safety and control interface 132 to control the subsystem(s) 124 of the vehicle 102, for example, in connection with executing the application(s) 114. Notably, though, the partitioned application processor 204 is configured to execute the application(s) 114 using its respective processor core(s) and the application processor memory 208. Through implementing a partition 212, the application(s) 114 are not executed using any core(s) of the safety processor(s) 202 and/or the safety processor memory 206. In at least one variation, the application(s) 114 are prevented from using cores and/or memory of the safety processor(s) 202.

In one or more implementations, the partition 212 is implemented at least in part by hardware partitioning as discussed above. Additionally, or alternatively, the partition 212 is implemented at least partially by software and/or firmware, such as by using the APIs 116. In one or more implementations, the partition 212 is implemented within a microprocessor, such as the partitioned application processor 204 by using one or more MMUs and/or one or more MPUs. In one or more implementations, the safety and control interface 132 is configured to implement the APIs 116. For example, the safety and control interface 132 can expose the custom application API 128 for use by the application(s) 114.

Accordingly, the partition 212 physically partitions the partitioned application processor 204 from other hardware components (e.g., the safety processor(s) 202 and the plurality of vehicle subsystem actuators 122) of the central control unit 120, and the partition 212 also functionally partitions the application(s) 114 from directly accessing or otherwise using those other components, such that the application(s) 114 are prevented from accessing any of the vehicle subsystems 124 without going through the safety and control interface 132.

In operation, an application(s) 114 requests that a vehicle subsystem(s) 124 perform some action during execution of the application(s) 114, e.g., to open or close a door, cause display of a user interface, turn lights on or off, travel to a destination according to navigation directions, interact with the pod 106, interact with the autonomous driving system 108, communicate with the remote service(s) 110 via the network(s) 112, and so on. In one or more implementations, the safety and control interface 132 arbitrates those requests, e.g., it permits a request or denies the request. If the safety and control interface 132 permits such a request, then control is passed to the safety processor(s) 202 which controls the respective vehicle subsystem actuator(s) 122 to actuate the corresponding vehicle subsystem(s) 124 to carry out the requested action. For example, after the safety and control interface 132 permits a request, the safety processor(s) 202 sends a command 214 to one or more of the vehicle subsystem actuators 122 to cause the respective vehicle subsystems 124 to perform the requested action. If the safety processor(s) 202 denies such a request, however, the safety processor(s) 202 does not carry out the requested action, e.g., the door is not opened or closed, the user interface is not displayed, the lights are not turned on or off, the pod 106 is not interacted with, the autonomous driving system 108 is not interacted with, the remote service(s) 110 are not communicated with, and so on. When the request is denied, the safety processor(s) 202 does not send a command 214 to any of the vehicle subsystem actuators 122 to perform the requested action. In at least one variation, the safety and control interface 132 discards denied requests. In one or more implementations, the safety and control interface 132 implements the custom application API 128 to permit or deny requests based on the safety rules 134, the safety goals 136, the application permissions 138, or a combination thereof.

In the context of the illustrated example 200, the partitioned application processor 204 executes application(s) 114 within the partition 212, such as by using one or more cores and the application processor memory 208 to execute instructions of those applications. Examples of such applications (e.g., custom, OEM, and third-party applications) are discussed above and below. Broadly, the application(s) 114 are intended to affect some aspect of the vehicle 102 during execution, such as to control interior climate, actuate a component (e.g., door or hatch), display user interfaces, to name just a few. To do so, an application(s) 114 outputs a request 216 to the APIs 116. The request 216 indicates at least one operation for at least one subsystem of the vehicle 102 to perform. For example, the request 216 indicates the operation of opening a door which is to be performed by a power door subsystem of the vehicle 102. From a hardware perspective, the partitioned application processor 204 transmits the request 216 to the safety processor(s) 202 via the safety and control interface 132 which can implement, for example, the custom application API 128 to arbitrate the request 216. In particular, the custom application API 128 receives the request 216 as input and determines whether to permit the request or deny the request 216. In one or more implementations, the custom application API 128 arbitrates the request 216 based at least in part on the safety rules 134. For example, if the custom application API 128 determines that the request 216 satisfies the safety rules 134, then the custom application API 128 permits the operation specified in the request 216. In connection with permitting the request 216, the safety processor(s) 202 outputs at least one command 214 that is transmitted over a vehicle network to actuate at least one vehicle subsystem actuator 122 to perform the requested operation. However, if the custom application API 128 determines that the request 216 does not satisfy the safety rules 134, then the custom application API 128 denies the operation specified in the request 216. In connection with denying the request 216, the safety processor(s) 202 does not output a command 214 to actuate at least one vehicle subsystem actuator 122 to perform the requested operation. Further, in at least one variation, the safety processor(s) 202 or the safety and control interface 132 discards a denied request.

Requests for changes in the state or interactions with a service that deals with potentially safety-critical functions can be managed by dividing access between applications of varying integrity levels, under the oversight of the central control unit's 120 safety-critical executive control. For instance, consider the functionality of a gull-wing door on the vehicle 102. Lower integrity applications within the application space are granted the ability to request the opening or closing of this door under specific vehicle conditions and contexts. However, the actual control and management of the door's operation, ensuring it adheres to the highest safety standards (ASIL-D level), are handled by the core software through the central control unit 120. This setup guarantees fault tolerance and mitigation, preventing the door from opening while the vehicle 102 is in motion, regardless of sensor or actuator failures or any requests from less reliable applications.

This approach effectively creates a decision-making process that combines (through logical AND, OR, or other operators) the requests 216 from lower integrity applications with the decisions made by the higher integrity central control unit's 120 software and the safety and control interface 132 that exposes the service, ensuring safety-critical items are managed appropriately.

Another example is the control of headlights. An application 114 might request to turn the headlights on or off during daylight, which could be for various reasons such as flashing the high beams. However, if the autonomous driving system 108 or the central control unit 120 has determined the headlights should be on, the safety and control interface 132 could reject any request 216 to turn the headlights off, maintaining safety standards. Conversely, a request 216 to turn the headlights on (when the headlights are already on) would be accepted, demonstrating how the safety logic prioritizes vehicle and passenger safety based on context.

In one or more implementations, the custom application API 128 outputs a response 218 to the application(s) 114 that sent the request 216. By way of example, the response 218 may indicate the custom application API's 128 determination made as a result of arbitrating of the request 216, such as whether the request 216 was permitted or denied. Additionally, or alternatively, the response 218 may include other information, examples of which include one or more reasons why the request 216 was permitted or denied, system messages associated with the request 216 (subsystem status or state messages), and so forth.

By arbitrating requests 216 from the application(s) 114 based on safety rules 134 that are ASIL-D compliant, the custom application API 128 ensures that operation of the vehicle 102 satisfies ASIL-D, even when executing third-party or custom applications which may not themselves satisfy ASIL-D requirements. In one or more implementations, the safety processor(s) 202 are ASIL-D compliant, such that the architecture of the safety processor(s) 202 and/or the operations they perform are configured to satisfy ASIL-D. For example, the safety processor(s) 202 are configured to control motion and vectoring of the vehicle 102 in a manner that satisfies ASIL-D. Since any requests from the application(s) 114 are architecturally routed through the safety processor(s) 202 and because the safety processor(s) 202 perform (e.g., only) operations which satisfy ASIL-D, the safety processor(s) 202 do not permit requested operations which fail to satisfy ASIL-D. Although ASIL-D is discussed in the immediately preceding example, it is to be appreciated that any vehicle safety standard or combination of them may be used in accordance with the described techniques.

Further advantages of this architecture include, but are not limited to, the extensive programmability of the vehicle's 102 user experience (e.g., within the vehicle and with applications on other devices such as mobile phones and/or tablets of a wide range of vehicle settings and/or functions) by a wide variety of users (in addition to the vehicle manufacturer), while maintaining one or more safety standards of certified integrity of the vehicle system 104 and the vehicle 102. Examples of such extensive and flexible programmability include but are not limited to, programming aspects of cabin user interface(s) and/or user experience, driver interface(s) and/or user experience, autonomous (non-driving) services, human machine interfaces, platform services, and vehicle pod and payload control and management, to name a few. Additionally, the application(s) 114 may be updated (e.g., as updates are made available via the cloud or other connection) without requiring recertification of the vehicle 102 to the desired or required safety standard, which can take years.

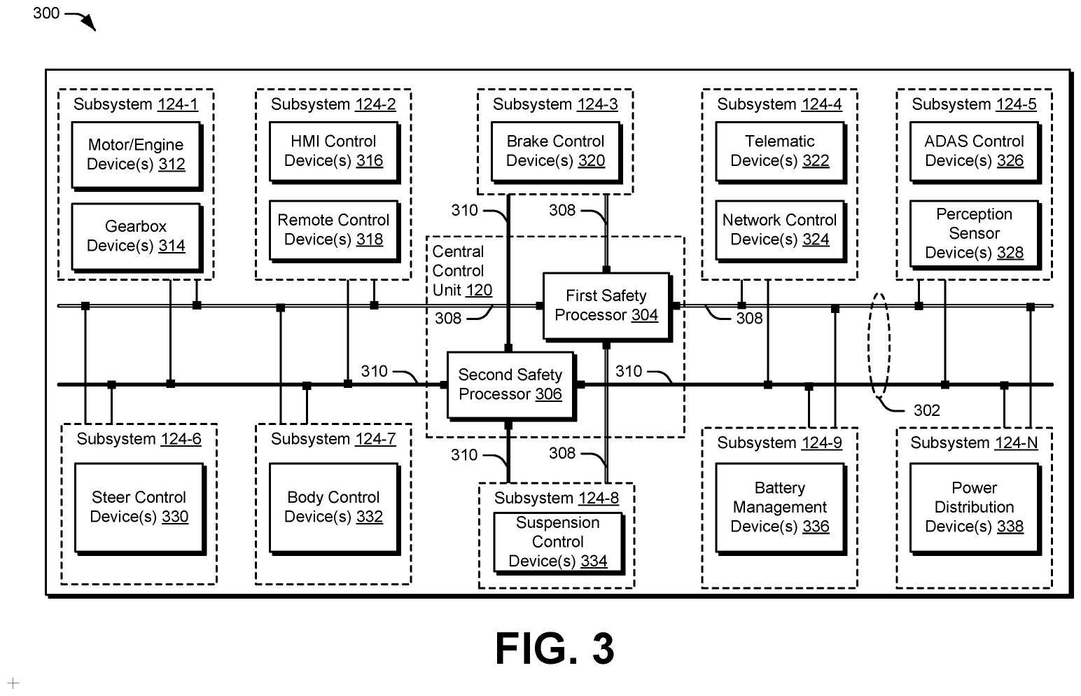

FIG. 3 is a block diagram of a non-limiting example of a system 300 that implements a safety control interface for safe vehicle operation. For ease of description, the system 300 is described in the context of the examples shown in FIG. 1 and FIG. 2, including with reference to similar labeled elements. For example, the system 300 includes a central control unit 120 and a plurality of subsystems 124 (labeled individually as subsystem 124-1 through subsystem 124-N, where N is any integer) that are managed by the central control unit 120 to implement various vehicle functions and services. In at least one example, the system 300 includes additional, fewer, and/or different subsystems 124 than those depicted in FIG. 3.

The central control unit 120 is configured as a centralized controller that enables information to transfer between the subsystems 124 over a vehicle network 302. By exchanging information with the subsystems 124, the centralized controller causes the execution of subsystem functions that enable driving. For instance, the central control unit 120 receives signals output on the vehicle network 302 from one of the subsystems 124, and based on information inferred from the signals, the central control unit 120 outputs additional signals on the vehicle network 302 to cause a particular behavior of another of the subsystems 124.

The central control unit 120 includes a first safety processor 304 and a second safety processor 306. The first safety processor 304 and the second safety processor 306 represent separate processors, processor cards, processor cores, control units, microcontrollers, system on chips, or other processor technology. Each of the first safety processor 304 and the second safety processor 306 are configured to execute instructions either as software or firmware to implement functionality of the central control unit 120. Although not shown, in some examples, the central control unit 120 includes a non-transitory computer-readable storage medium (e.g., data store, cache, static memory, dynamic memory, flash memory, disk storage) that maintains the instructions and data for implementing the instructions executed by each of the first safety processor 304 and the second safety processor 306. For example, the first safety processor 304 and the second safety processor 306 include respective data stores that contain the instructions retrieved from the data stores and executed during operation of the vehicle 102.

In at least one variation, the central control unit 120 is distributed throughout the system 300 in two or more locations. In such a distributed implementation, the first safety processor 304 is included in a first control system and the second safety processor 306 is included in a second control system. In other distributed implementations, each control system includes one or more safety processors.

In one or more examples, the first safety processor 304 and the second safety processor 306 are functionally redundant. The system 300 relies on either the first safety processor 304 or the second safety processor 306 (e.g., one at a time) to actively cause operations to be performed by the subsystems 124. For example, while the first safety processor 304 is orchestrating operations of the subsystems 124, the second safety processor 306 is maintained in a ready, standby state. Notably, in this ready standby state, the second safety processor 306 also runs as if it is operating the vehicle, e.g., making vehicle control and vectoring decisions as if it is responsible for operating the vehicle in real-time.

If the first safety processor 304 fails, then the central control unit 120 activates the second safety processor 306 to seamlessly take over and manage the subsystems 124 where the first safety processor 304 left off. When the second safety processor 306 takes over, the vehicle 102 may be forced to operate in a safe state, which can include fail-operational methods such as autonomously maneuvering away from other vehicles, objects, and pedestrians to come to a controlled stop. This way, the functional redundancy implemented by the first safety processor 304 and the second safety processor 306 help the central control unit 120 to satisfy ASIL-D requirements for reliability and safety. In such implementations, the first safety processor 304 and the second safety processor 306 may be located at different locations within the vehicle.

The vehicle network 302 represents any suitable vehicle network technology, including wired and wireless signal propagation mediums. The vehicle network 302 enables real-time data exchange, safety enhancements, and efficient traffic management among the components of the system 300. The vehicle network 302 can include various switches, routers, transceivers, controllers, chokes, filters, terminations, and other networking equipment beyond transmission lines, cables, wires, busses, and other signal routing technologies. In at least one implementation, the vehicle network 302 adheres to an in-vehicle networking protocol. For example, the vehicle network 302 represents a combination of one or more of a controller area network (CAN), an automotive ethernet network (AEN), serializer/deserializer (SerDes) network, local interconnect network (LIN), or a FlexRay network (FRN), to name a few.

In at least one example, to implement the redundancy of the central control unit 120, the vehicle network 302 is composed of dual physical network paths. A network path 308 communicatively couples each of the subsystems 124 to the first safety processor 304. A separate network path 310 communicatively links each of the subsystems 124 to the second safety processor 306. For example, if a failure at the first safety processor 304 is at least partially caused by a fault in the network path 308, the second safety processor 306 is unaffected by the network fault and operable to communicate with the subsystems 124 using the network path 310. The functional redundancy implemented by the network paths 308, 310 further helps the central control unit 120 to satisfy the ASIL-D requirements for reliability and safety.

In at least one other example, to implement the redundancy of the central control unit 120, the vehicle network 302 is composed of dual logical network paths. The network path 308 and the network path 310 may be separate logical paths through the vehicle network 302 that communicatively link each of the subsystems 124 to the first safety processor 304 and the second safety processor 306 using the same physical wires. For example, communications to and from the first safety processor 304 and the second safety processor 306 are interleaved on a single set of wires that make up the vehicle network 302. If a failure at the second safety processor 306 and/or the network path 310 occurs, communications from the first safety processor 304 can reach the subsystems 124 using the network path 308. The functional redundancy implemented by interleaving the network paths 308, 310 further helps the central control unit 120 to satisfy the ASIL-D requirements for reliability and safety.

The subsystems 124 include one or more edge devices operatively coupled to the vehicle network 302 to provide information to the central control unit 120 and receive commands from the central control unit 120 to implement various vehicle functions. For example, each of the subsystems 124 can include one or more actuators, microcontrollers, machines, or other equipment to perform specific vehicle tasks at the discretion of the edge devices that are contained within the subsystems 124.

In one or more implementations, the vehicle 12 includes a subsystem 124-1 which is a propulsion or drive subsystem. Motor/engine devices 312 of the subsystem 124-1 represent edge devices managed by the central control unit 120 to command vehicle propulsion units (e.g., an engine, a motor) to execute driving functions of the vehicle 102 (e.g., forward motion, reverse motion, acceleration, deceleration). In one or more examples, the motor/engine devices 312 manage operations of an engine of the vehicle 102, including fuel injection, ignition timing, emissions control, and engine health monitoring. In at least one aspect (e.g., in context of electric vehicles), the motor/engine devices 312 control inverters and motors that convert electric energy into mechanical energy for applying torque to wheels.

In addition, the subsystem 124-1 includes gearbox devices 314. Also referred to as a powertrain control module (PCM) and/or a transmission control module (TCM), transmission and gearbox functions are overseen by the gearbox devices 314 to implement an automatic transmission, optimize gear changes (e.g., gear shifts), and control torque delivered to the wheels of the vehicle 102. In variations, a vehicle may include one or more subsystems 124-1, e.g., one subsystem 124-1 for each axle.

A subsystem 124-2 is a human machine interface (HMI) subsystem. The subsystem 124-2 includes one or more HMI control devices 316 that implement a vehicle user interface. The vehicle user interface enables interaction between occupants (e.g., driver, passenger) of the vehicle 102 and the system 300, which enables human intervention in vehicle functions and driving. For example, the HMI control devices 316 control vehicle displays, vehicle dash clusters, heads-up display units, haptic feedback, audible feedback, and other visual driving aids interpreted by the occupants to help with driving or ensuring safe vehicle operations. In one or more implementations, the HMI control devices 316 provide a human-interface to effect climate controls (e.g., heating, cooling), cabin features (e.g., infotainment, lighting), and other vehicle body features (e.g., windshield wipers, transmission settings, suspension settings, drive mode selection, power seating, power mirrors, power door locks, etc.).

The subsystem 124-2 also includes one or more remote control devices 318 that allow human or machine inputs to control the vehicle 102 from outside the cabin. For example, in an autonomous or semi-autonomous vehicle context, the remote control devices 318 receive commands over a communication link with a base station (e.g., a mobile phone, a key fob, a remote computing system) to allow a human or machine operator to control the vehicle 102 as if the driving commands are provided directly to the HMI control devices 316. In hot or cold weather, to pre-cool or pre-heat the cabin, the remote control devices 318 may activate remote starting functions. The remote control devices 318 in at least one aspect allow door locks to be locked or unlocked and doors, tailgates or trunks to be remotely opened or closed.

A subsystem 124-3 represents a braking subsystem of the system 300. For example, one or more brake control devices 320 are operable to manage anti-lock braking systems (ABS), electronic stability controls (ESC), and otherwise convert driver inputs at the HMI control devices 316 to effect performance of vehicle brakes (e.g., for stopping, for decelerating, etc.). In some examples, the brake control devices 320 represent a braking control module (BCM).

Another of the subsystems 124 depicted in FIG. 3 is subsystem 124-4, which is an onboard-vehicle communication subsystem. The subsystem 124-4 manages telematics and communications that occur within the vehicle 102, and with other devices located outside the vehicle 102. For example, the subsystem 124-4 interfaces with the various edge devices coupled to the vehicle network 302 to ensure healthy exchange of data that is free of errors or faults. In addition, the subsystem 124-4 interfaces with other vehicles, mobile devices, infrastructure, and remote computing systems to implement various vehicle functions. One or more network control devices 324 of the subsystem 124-4 monitor network health of the vehicle network 302 and facilitate communication protocols implemented therein. The network control devices 324 are configured to diagnose problems with the vehicle network 302 to reroute signals and prevent data loss.

One or more telematic devices 322 of the subsystem 124-4 handle offboard communications of the vehicle 102. This includes implementing vehicle-to-vehicle (V2V) and vehicle-to-everything (V2X) communications that enable the vehicle 102 to communicate with other intelligent vehicles and systems in an operating environment, e.g., on or near a roadway. The telematic devices 322 interface with over-the-air (OTA) update services to update software on the vehicle 102, such as the application(s) 114 and/or firmware or software executed by the first safety processor 304 and/or the second safety processor 306, e.g., the custom application API 128 and/or a vehicle operating system. In addition, the telematic devices 322 interface with a positioning system to assist with navigation functions. Other features implemented by the telematic devices 322 include remote diagnostics and interfacing with emergency response services, e.g., to automatically alert emergency responders in the event of an accident.

Subsystem 124-5 is an advanced driving and safety (ADAS) subsystem of the system 300. In at least one implementation, the subsystem 124-5 has two main functions, including implementing an ADAS as well as a perception sensor system. For example, one or more ADAS control devices 326 implement ADAS functionality that includes autonomous or semi-autonomous control, adaptive cruise control, emergency braking, lane centering, and other ADAS functions. One or more perception sensor devices 328 support the ADAS control devices 326 by providing information about the driving environment to ensure safe driving. For example, a radar, a camera, a lidar, an ultrasonic sensor, a global position system (GPS) sensor, an inertial measurement unit (IMU), and other sensor technology is deployed by the perception sensor devices 328 to collect sensor data about a vehicle environment. Sensor fusion techniques, object detection, lane centering, path trajectory planning, and other perception sensor functions are executed by the perception sensor devices 328 to enable the ADAS functions performed by the ADAS control devices 326.

Subsystem 124-6 is a steering subsystem that controls components of the vehicle which steer the wheels. One or more steer control devices 330 integrate with an electric power steering system of the vehicle 102 to control direction of the vehicle wheels. The steer control devices 330 may receive inputs from the HMI control devices 316 and/or the central control unit 120, which are translated into appropriate steering commands for controlling steering actuators that change the direction of the wheels for steering and performing evasive maneuvers.

Subsystem 124-7 represents a body control subsystem of the vehicle 102. Included in the subsystem 124-7 are one or more body control devices 332, which handle functions related to vehicle body controls. For example, window actuators, door locks and latches, interior and exterior lighting, tailgate and trunk latches, and the like are controlled by the body control devices 332 at the command of the central control unit 120 and/or one or more of the other subsystems 124 (e.g., the HMI control devices 316).

Subsystem 124-8 is an active suspension control subsystem. One or more suspension control devices 334 implement functions of a suspension control module (SCM) to regulate suspension components to adjust a ride level of the vehicle 102. For example, the suspension control devices 334 configure a vehicle suspension to be stiffer on paved surfaces for improved driving performance and maneuverability. In an offroad setting, though, the suspension control devices 334 may enable a softer suspension setting to provide a smoother ride.

Subsystem 124-9 represents a battery management subsystem of the vehicle 102. One or more battery management devices 336 monitor performance of a battery pack (also referred to as a traction battery) to ensure appropriate charging and discharging rates to promote longevity and overall battery health. The battery management devices 336 control charging operations of onboard vehicle batteries as well as controlling battery usage, e.g., to control a rate of discharge. The battery management devices 336 monitor health of vehicle batteries to alert the central control unit 120 when a malfunction is imminent or occurring.

Finally, subsystem 124-N is depicted in FIG. 3, which represents a power distribution system. In variations, one or more power distribution devices 338 of the subsystem 124-N manage the distribution of electrical power from energy sources on the vehicle 102 to the system 300. For example, the power distribution devices 338 control power switches, inverters, converters, and other electrical distribution components to ensure the subsystems 124 receive an appropriate level of current and voltage for implementing vehicle functions. The power distribution devices 338 can include fault protection circuits and breakers to interrupt power to a faulty subsystem and maintain safe electrical conditions while the vehicle 102 remains active. The power distribution devices 338 interface with the motor engine devices 312 and the battery management devices 336 to manage safe electrical conditions throughout the system 300.

The various subsystems 124 may be controlled by the first safety processor 304 and/or second safety processor 306 (examples of the safety processor(s) 202) in connection with a variety of use cases implemented by custom applications (e.g., the applications 114) executed by the partitioned application processor 204.

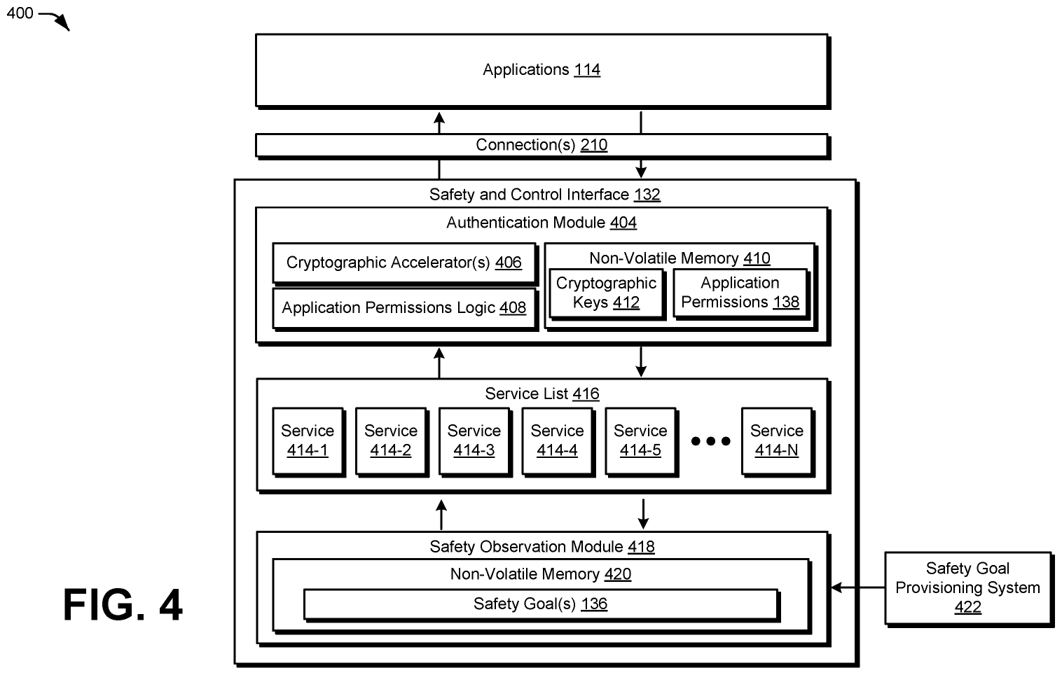

FIG. 4 depicts an example implementation 400 of a safety control interface for safe vehicle operation. The example implementation 400 includes a plurality of applications 114. The applications 114 can interact with the safety and control interface 132 via the connection(s) 210. As noted above, the safety and control interface 132 can be implemented as part of the connection(s) 210 or can be implemented separately from the connection(s) 210 and can monitor communications over the connection(s) 210 to intercept, for example, requests from the application(s) 114 to access the vehicle subsystem actuators 122. Moreover, the connection(s) 210 can be separate from or part of the vehicle network 302. Similar to the vehicle network 302, the connection(s) 210 can be implemented as a combination of one or more of a CAN, an AEN, a SerDes network, a LIN, or an FRN, to name a few. Wireless connections are also contemplated.

In the example implementation 400, the safety and control interface 132 includes an authentication module 404. The illustrated authentication module 404 includes one or more cryptographic accelerators 406, application permissions logic 408, and a non-volatile memory 410. The non-volatile memory 410 is configured to store cryptographic keys 412 (e.g., public and private keys) and the application permissions 138.

The cryptographic accelerator(s) 406 is configured to perform cryptographic operations, such as encryption and decryption using the cryptographic keys 412. By using the cryptographic accelerator(s) 406, the safety and control interface 132 offloads the computationally intensive tasks involved in cryptography from the safety processor 202, thereby enhancing overall vehicle system 104 performance, reducing latency, and increasing the security of cryptographic operations by handling the cryptographic keys 412 and data within a dedicated, tamper-resistant environment provided by the safety and control interface 132. The cryptographic accelerator(s) 406 can be implemented in hardware, software, or both hardware and software.

The cryptographic keys 412 can include a public key shared between the central control unit 120 (and specifically the safety and control interface 132) and one or more external services that can create, manage, and disseminate the application permissions 138 to the central control unit 120 upon request. The external services can be local as part of the vehicle 102 or external such as part of the remote services 110. In any case, the cryptographic accelerator(s) 406 can use a private key of the cryptographic keys 412 to decrypt the application permissions 138 for execution by the application permissions logic 408. In this manner, the application(s) 114 is not aware of its permissions and merely passes the application permissions 138 on to the safety and control interface 132, e.g., as part of the request(s) 216. In one or more implementations, the external service(s) can be provided by a manufacturer of the vehicle 102 and/or another entity that has authority to ensure that the vehicle 102 remains in compliance with the safety rules 134 when executing the applications(s) 114.

As described above, the application permissions 138 define to which services of the vehicle 102 the application(s) 114 have access and what operations can be performed. The application permissions 138 are used by the safety and control interface 132 to grant or deny the application(s) 114 authority to use specific resources and/or execute certain operations. For instance, the application permissions 138 control what types of commands 214 the application(s) 114 can request the safety processor(s) 202 to send to the vehicle subsystem actuators 122. In this manner, the application permissions 138 can be used to ensure that the safety rules 134 are satisfied with respect to the services the application(s) 114 can and cannot access. In the illustrated example, the safety and control interface 132 maintains a service list 416

The application permissions 138 can be static or dynamic. For instance, the application permissions 138 can be established when the application(s) 114 is installed on the vehicle 102 such as part of a commissioning process for a mission and remain static until removed or changed, e.g., as part of another commissioning process for another mission.

After the cryptographic accelerator(s) 406 authenticates the application(s) 114 using the cryptographic keys 412, the application permissions logic 408 uses the application permissions 138 to authorize the application(s) 114 to access (or not) one or more services 414 (labeled individually as service 414-1 through service 414-N), where N is any integer) identified in a service list 416 maintained by the safety and control interface 132. The service list 416 can be updated from time-to-time as new services are added to or removed from the vehicle 102, such as via the pods 106, other interchangeable components of the vehicle 102, or for any other reason. The request(s) 216 originating from the application(s) 114 can identify the service(s) 414. Alternatively, the application permissions logic 408 can extrapolate which of the service(s) 414 are applicable based on information included in the request(s) 216.

The safety and control interface 132 also includes a safety observation module 418 configured to store, in a non-volatile memory 420, the safety goal(s) 136. As described above, the safety goals 136 represent desired outcomes that a person, organization, the vehicle 102 itself, and/or any other entity aims to achieve. The safety goal(s) 136 can be used as part of a safety check performed by the safety observation module 418. The safety check ensures that the application(s) 114 do not access the services 414 of the vehicle 102 if the access would violate the safety goals 136, even if the application(s) 114 have appropriate application permissions 138. In some instances, the safety goals 136 can be achieved by strict adherence to the safety rules 134. In other instances, the safety goals 136 are aspirational or otherwise exceed the requirements specified in the safety rules 134. In one or more implementations, the safety goals 136 are provisioned by the manufacturer of the vehicle 102 as part of a commissioning process during which software components, such as the application(s) 114 and the vehicle operating system 118, are installed, configured, tested, validated, and fine-tuned prior to deploying the vehicle 102 for its intended purpose. In the illustrated example, the safety goals(s) 136 are provisioned to the vehicle 102, and particularly the safety observation module 418 of the safety and control interface 132, via a safety goal provisioning system 422.

The safety goal provisioning system 422 can be a computer system, device, other hardware, software, firmware, or combination thereof that is used, in some instances, during a vehicle commissioning process to identify and load into the vehicle 102 the safety goal(s) 136 to which the vehicle 102 must adhere, such as in compliance with the safety rule(s) 134.

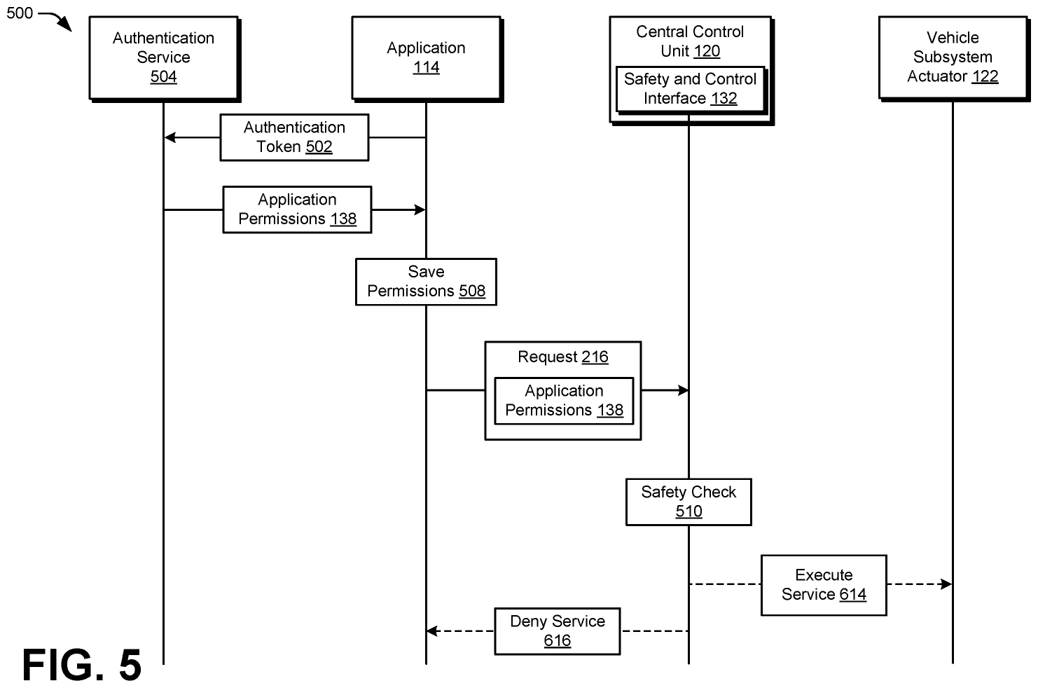

FIG. 5 is a sequence diagram of a non-limiting example authentication and safety check process 500 for safe vehicle operation while executing one or more applications. The process 500 begins when the application 114 generates and sends an authentication token 502 to an authentication service 504, such as a local service executed on the vehicle 102 or the remote service(s) 110. The authentication token 502 is a digital key used to verify that the application 114 is certified (e.g., by the manufacturer or the vehicle 102) and not malicious. Upon verifying the authentication token 502, the authentication service 504 provides the application permissions 138 to the application 114. The application 114 can save the application permissions 138 (shown at 508).

The application 114 can be authenticated for a specified time, after which the authentication expires and the application 114 must once again generate and send the authentication token 502 to the authentication service 504 to be re-authenticated. Alternatively, the authentication may be limited use, such that the application 114 can make a specified number of requests 216 to the central control unit 120 until re-authentication is needed. The application 114, in some implementations, can periodically check the authentication status to ensure the application 114 is authenticated and has the most recent version of the application permissions 138. Alternatively, the authentication service 504 can ping the application 114 for the authentication token 502 from time-to-time, such as periodically, randomly, or based on a pattern.

The application 114 then generates a request 216 indicating at least one operation for at least one subsystem of the vehicle 102 to perform, for example, as part of executing one or more of the services 414. In one or more implementations, such as in the illustrated example, the request 216 includes the application permissions 138. The application 114 then provides the request 216 to the central control unit 120. Alternatively, the application 114 provides the request 216 and the application permissions 138 separately to the central control unit 120.

The central control unit 120, and specifically the safety and control interface 132, performs a safety check 510 to determine whether the application 114 has the correct application permissions 138 for the requested operation(s) and, if so, whether the application 114 accessing the service(s) 414 to perform the operation(s) would adhere to and maintain the safety goal(s) 136. If the safety check 510 results in the safety and control interface 132 determining that the application 114 has the correct application permissions 138 for the requested operation(s) and the application 114 accessing the service(s) 414 to perform the operation(s) would maintain the safety goal(s) 136, then the safety check 510 passes and the central control unit 120 can submit one or more commands 214 to the appropriate vehicle subsystem actuator(s) 122 to execute the service as shown at block 614. Otherwise, the central control unit 120 can inform the application 114 that the request 216 is denied.

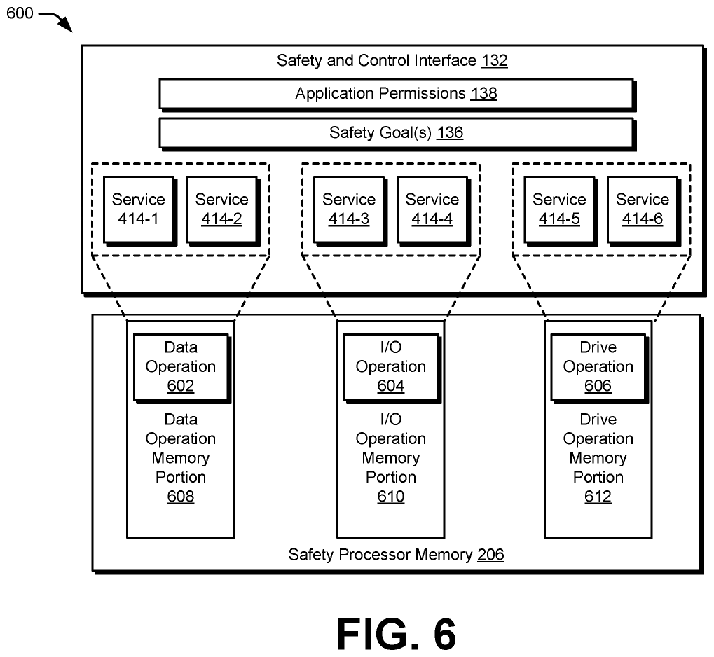

FIG. 6 depicts an example implementation 600 of a safety and control interface to allocate memory resources based on a type of operation associated with a requested service. The implementation 600 depicts the safety and control interface 132 that controls access to the services 414, such as via the authentication and safety check process described above, using the application permissions 138 and the safety goal(s) 136. The implementation 600 also shows the safety processor memory 206 introduced in FIG. 2.

For the illustrated example, it should be assumed that an application 114 has requested access to multiple services to perform different operations and has been allowed access based on satisfying the application permissions 138 and the safety goals 136. Specifically, the illustrated example shows services 414-1, 414-2 associated with data operations 602, services 414-3, 414-4 associated with input/output operations 604, and services 414-5, 414-6 associated with drive operations 606. The specific operation types—data, I/O, and drive—are shown merely as an illustrative example of the types of operations the services 414 can provide.

Instructions for executing each of these operation types (i.e., data operations 602, input/output operations 604, and drive operations 606) are loaded into respective portions 608, 610, 612 (e.g., segments or regions) of the safety processor memory 206 for execution by the safety processor(s) 202. In this manner, the safety processor memory 206 can provide protected memory access which can provide additional security from malicious or malfunctioning applications even if these applications successfully pass the application permissions 138 and the safety goal(s) 136.

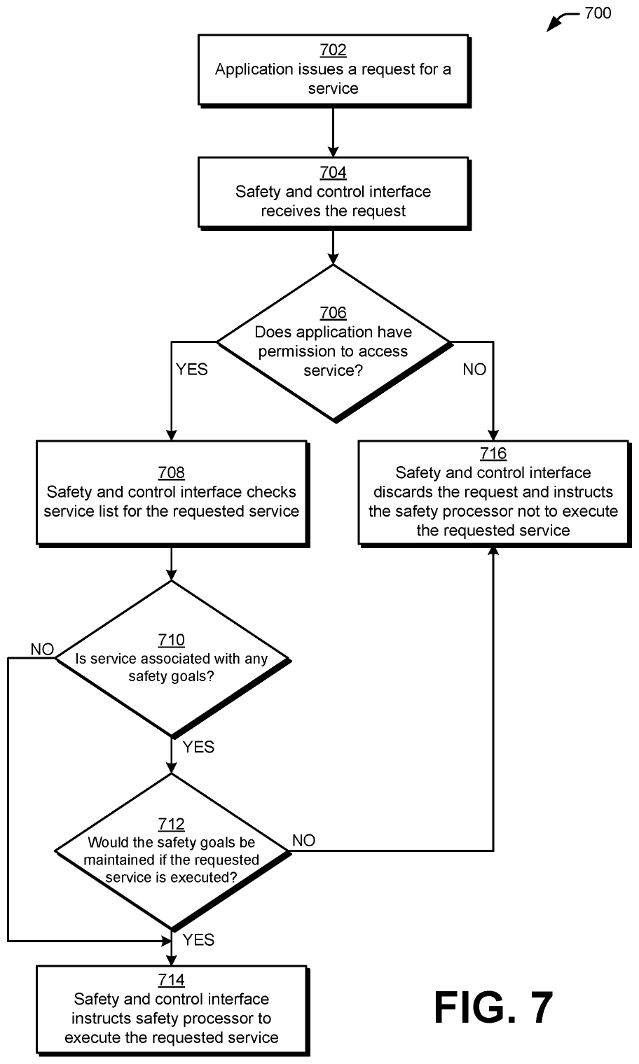

FIG. 7 depicts a procedure 700 in an example implementation of a safety control interface for safe vehicle operation. The procedure 700 begins at block 702, where an application 114 issues a request 216 for a service 414. The request 216 can identify the service 414 and can include one or more application permissions 138. As discussed above with respect to FIG. 5, the application permissions 138 can be obtained by the application 114 from the authentication service 504, such as a local service executed on the vehicle 102 or the remote service(s) 110.

Before or after block 704, the safety and control interface 132 can present the permitted services that the application 114 can access. For instance, in a typical scenario, the application 114 starts by initializing and then moves to a phase where the application 114 identifies available services through the safety and control interface 132. This process results in creating a list of services that the application 114 is allowed to use, which the application 114 can cross-reference with its expected functionalities.

The list of permitted services and instructions can be used by the application 114 to block or filter out any requests 216 the application 114 makes that are not allowed by the safety and control interface 132. This can be done in real-time, acting as a context-sensitive filter during operation, or can be set up in advance as a safety feature within the application 114. Such measures not only enhance the safety of the application 114, but may also contribute to its compliance with ASIL standards.

Moreover, this approach could be advantageous for the certification of the entire vehicle 102, particularly for components of medium to high integrity. This approach allows applications with lesser safety implications to achieve certification up to a certain ASIL level (e.g., ASIL-B), enhancing the overall safety certification of the vehicle 102. At block 704, the safety and control interface 132 receives the request 216 from the application 114. In response, the safety and control interface 132 determines, at block 706, whether the application 114 has the application permissions 138 required to access the requested service 414. In other words, the safety and control interface 132 determines whether the application 114 is authenticated to access the requested service 414 based on the application permissions 138. If so, at block 708, the safety and control interface 132 checks the service list 416 for the requested service 414.

At block 710, the safety and control interface 132 determines if the requested service 414 is associated with any safety goals 136. If so, the safety and control interface 132 determines, at block 712, whether the safety goals 136 would be maintained if the requested service 414 is executed. If so, at block 714, the safety and control interface 132 instructs the safety processor 202 to execute the requested service 414. If, however, at block 710, the safety and control interface 132 determines that the request service 414 is not associated with any safety goals 136, then the safety and control interface 132, at block 714, the safety and control interface 132 instructs the safety processor 202 to execute the requested service 414.

Returning to block 712, if the safety and control interface 132 determines that the safety goals would not be maintained if the requested service 414 is executed, the safety and control interface, at block 716, discards the request 216 and instructs the safety processor 202 not to execute the requested service 414.

Returning to block 706, if the safety and control interface 132 determines that the application 114 does not have permission to access the requested service 414 based on the application permissions 138, then the safety and control interface 132, at block 716, discards the request 216 and instructs the safety processor 202 not to execute the requested service 414.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include read only memory (ROM), random-access memory (RAM), a register, cache memory, semiconductor memory devices, magnetic media such as internal hard disks and removable disks, and magneto-optical media.

What is claimed is:

1. A system comprising:
one or more subsystems of a vehicle, each of the one or more subsystems configured to perform an operation of the vehicle;
a first processor configured to execute applications associated with the vehicle;
a safety and control interface configured to:
receive a request for a service from an application executed by the first processor;
determine whether the application has an application permission to access the service; and determine whether executing the service would maintain a safety goal established for the vehicle; and
a second processor configured to execute the service requested by the application based on the safety and control interface determining that the application has the application permission to access the service and that executing the service responsive to the request would maintain the safety goal established for the vehicle.

2. The system of claim 1, wherein the second processor, in being configured to execute the service, is configured to cause actuation of at least one of the one or more subsystems of the vehicle.

3. The system of claim 1, wherein the request includes the application permission.

4. The system of claim 3, wherein the application permission is provided to the application for inclusion in the request by an authentication service.

5. The system of claim 1, wherein the safety and control interface is further configured to receive the safety goal as part of a commissioning process.

6. The system of claim 5, wherein the safety goal is defined by a manufacturer of the vehicle during the commissioning process.

7. The system of claim 1, wherein the application permission is implemented to satisfy, at least in part, a safety rule applied to the vehicle.

8. The system of claim 7, wherein the safety rule is implemented to satisfy Automotive Safety Integrity Level D (ASIL-D) operation of the vehicle.

9. The system of claim 1, wherein the safety and control interface is configured to intercept the request sent from a connection between the first processor and the second processor.

10. The system of claim 1, wherein the safety and control interface is configured as part of a connection between the first processor and the second processor.

11. The system of claim 1, wherein the safety and control interface includes one or more application programming interfaces and exposes the one or more application programming interfaces to the application.

12. An electronic control unit for controlling operation of a vehicle, the electronic control unit comprising:
a first processor configured to execute applications associated with the vehicle;
a safety and control interface configured to:
receive a request for a service from an application executed by the first processor; and
perform a safety check to determine whether the application is allowed to utilize the service; and
a second processor configured to execute the service or deny the service based on the safety check.

13. The electronic control unit of claim 12, wherein, in being configured to perform the safety check, the safety and control interface is configured to determine whether the application has an application permission required to access the service.

14. The electronic control unit of claim 13, wherein, in being configured to perform the safety check, the safety and control interface is configured to, responsive to determining that the application does not have the application permission required to access the service, discard the request and instruct the second processor to deny the service.

15. The electronic control unit of claim 13, wherein, in being configured to perform the safety check, the safety and control interface is configured to, responsive to determining that the application does have the application permission required to access the service, determine whether the service is associated with one or more safety goals.

16. The electronic control unit of claim 15, wherein, in being configured to perform the safety check, the safety and control interface is configured to, responsive to determining that the service is not associated with the one or more safety goals, instruct the second processor to execute the service.

17. The electronic control unit of claim 15, wherein, in being configured to perform the safety check, the safety and control interface is configured to, responsive to determining that the service is associated with the one or more safety goals, instruct the second processor to determine whether the one or more safety goals would be maintained if the service is executed.

18. The electronic control unit of claim 17, wherein, in being configured to perform the safety check, the safety and control interface is configured to, responsive to determining that the one or more safety goals would be maintained if the service is executed, instruct the second processor to execute the service.

19. The electronic control unit of claim 17, wherein, in being configured to perform the safety check, the safety and control interface is configured to, responsive to determining that the one or more safety goals would not be maintained if the service is executed, discard the request and instruct the second processor not to execute the service.

20. A method comprising:
receiving, by a safety and control interface of an electronic control unit of a vehicle, a request for a service from an application;
determining, by the safety and control interface, whether the application has a permission to access the service;
responsive to determining that the application has the permission to access the service, determining, by the safety and control interface, whether the service is associated with a safety goal;
responsive to determining that the service is associated with the safety goal, determining, by the safety and control interface, whether the safety goal would be maintained if the service is executed; and
responsive to determining that the safety goal would be maintained if the service is executed, instructing, by the safety and control interface, a processor of the electronic control unit, to execute the service, at least in part, by actuating one or more subsystems of the vehicle.
